(19) United States
(12) Patent Application Publication
(10) Pub. No.: US 2025/0101258 A1
(43) Pub. Date: Mar. 27, 2025

(54) COMPOSITIONS COMPRISING MODIFIED LIGNIN USEFUL FOR ADDITIVE MANUFACTURING

(71) Applicant: Albert-Ludwigs-Universität Freiburg, Freiburg (DE)

(72) Inventors: Marie-Pierre LABORIE, Bad Krozingen (DE); Lisa-Sophie BILLHARZ, Hamburg (DE); Wolfgang GLASSER, Richmond, VA (US)

(73) Assignee: Albert-Ludwigs-Universität Freiburg, Freiburg (DE)

(21) Appl. No.: 18/700,761

(22) PCT Filed: Oct. 17, 2022
(86) PCT No.: PCT/EP2022/078782

§ 371 Date: Apr. 12, 2024

(30) Foreign Application Priority Data
Oct. 15, 2021 (EP) 21202808.8

(51) Int. Cl. C09D 197/00; B33Y 70/00; C09D 7/20; C09D 101/28

(52) U.S. Cl. CPC C09D 197/005; B33Y 70/00; C09D 7/20; C09D 101/284

(57) ABSTRACT

The present invention relates to compositions comprising modified lignin and modified cellulose which are suitable for use in additive manufacturing (e.g. 3D printing), in particular for direct ink writing (DIW). In particular, the invention relates to a composition suitable for direct ink writing, comprising a) a functional ether of lignin, b) a functional ether of cellulose, and c) a solvent comprising an aliphatic alcohol and optionally water. The content of the functional ether of lignin in the composition is at least 25 wt. % based on the combined weights of functional ether of lignin and functional ether of cellulose.

### CROSS-REFERENCE TO RELATED APPLICATIONS

This is the U.S. national stage of international patent application no. PCT/EP2022/078782, filed Oct. 17, 2022 designating the United States and claiming priority to European patent application no. EP 21202808.8, filed Oct. 15, 2021, the disclosures of which are incorporated herein by reference in their entireties

### DESCRIPTION

The present invention relates to compositions comprising modified lignin and modified cellulose which are suitable for use in additive manufacturing (e.g. 3D printing), in particular for direct ink writing (DIW). In particular, the invention relates to a composition suitable for direct ink writing, comprising a) a functional ether of lignin, b) a functional ether of cellulose, and c) a solvent comprising an aliphatic alcohol and optionally water. The content of the functional ether of lignin in the composition is preferably at least 25 wt. % based on the combined weights of functional ether of lignin and functional ether of cellulose.

### BACKGROUND OF THE INVENTION

Additive manufacturing (AM), also known as 3D printing, is a transformative approach to industrial production that enables the creation of lighter, and potentially stronger parts and systems that can be individualized.

Additive manufacturing uses data computer-aided-design (CAD) software or 3D object scanners to direct hardware to deposit material, layer upon layer, in precise geometric shapes. As its name implies, additive manufacturing adds material to create an object. By contrast, when you create an object by traditional means, it is often necessary to remove material through milling, machining, carving, shaping or other means.

In the course of the development towards sustainable technologies, 3D printable biopolymers have found increasing interest in the recent past as alternatives to traditional petroleum-based polymers.

Within the group of bio-based polymers, wood polymers show an interesting property profile for the development and formulation of bio-based inks and filaments for 3D printing.

Direct ink writing (DIW) is an extrusion-based technique of 3D printing which can process polymer-based pastes at room temperature. Compared to FDM techniques there is no need in DIW to heat the ink above a melting or softening point for processability. The main challenge in DIW is to achieve suitable viscoelastic properties so that the ink can easily flow through the nozzle during printing and form free standing structures after extrusion.

Strong shear thinning properties and low zero rate shear compliance are important prerequisites for polymeric inks in DIW. Polymeric gels are particularly suited for DIW.

In the drive towards a sustainable economy, 3D printable bio-based polymers are receiving increased attention as alternatives to traditional petroleum-based polymers. Amongst the bio-based polymers, wood polymers are an interesting group. In particular lignin is starting to get increasing attention in this regard.

Lignin is the most abundant naturally occurring phenolic compound and is readily available as it is formed in significant amounts as a by-product in many wood processing techniques. With its modulus-building aromatic rings and its high reactivity imparted by its phenolic hydroxyls and insaturations, lignin provides the necessary compression strength to vascular plants as well as the molecular reactivity needed for intermolecular interactions. It can be observed in nature that, using a limited number of building blocks with slight molecular variations, tailoring its chemico-physical attributes such methoxyl functionalities, a broad span and fine tuning of the mechanical function of lignin is locally designed and regulated in trees. In the vegetal kingdom, the natural variation and diversity to adjust to a particular mechanical function relies essentially on molecular variations in the amorphous matrix of wood, i.e., in the lignin and hemicellulose components. However, once extracted from biomass, lignins suffer from their variability in molecular size and chemical structures, thus complicating their utilization in polymeric systems. Furthermore, as a natural polymer, lignin has not been designed for man-made manufacturing processes and as such lacks the solubility or thermoplasticity needed to enable such processing.

Nevertheless, lignin, due to its availability in large amounts and its low price, is starting to receive increasing attention in 3D printing applications.

To date, lignin has been mainly 3D printed by stereolithography (SLA) and fused deposition modeling (FDM) technologies. Photocurable polyurethane reinforced with organosolv lignin (OSL) (Ibrahim, F. et al. Evaluation of the Compatibility of Organosolv Lignin-Graphene Nanoplatelets with Photo-Curable Polyurethane in Stereolithography 3D Printing. Polymer 2019, 11) and lignin-containing resins (Sutton, J. T.et al. Lignin-Containing Photoactive Resins for 3D Printing by Stereolithography, ACS Appl Mater Interfaces 2018, 10, 36456-36463; Zhang, S.et al. Stereolithography 3D Printing of Lignin-Reinforced Composites with Enhanced Mechanical Properties. ACS Omega 2019, 4, 20197-20204) have been successfully processed by SLA; likewise, lignin-coated CNCs were incorporated into methacrylate resin for creating nanocomposites (Feng, X. et al. Lignin-coated cellulose nanocrystal filled methacrylate composites prepared via 3D stereolithography printing: Mechanical reinforcement and thermal stabilization. Carbohydr. Polym. 2017, 169, 272-281). In FDM, lignin has been mostly utilized within polymer blends with thermoplastic polymers. Blends of lignin with bio-based polymers such as poly lactic acid (Tanase-Opedal, M. et al. Lignin: A Biopolymer from Forestry Biomass for Biocomposites and 3D Printing Materials 12 (18) (2019) doi: 10.3390/ma12183006; Gkartzou, E. et al. Production and 3D printing processing of bio-based thermoplastic filament Manuf. Rev. 4, 1 (2017) doi: 10.1051/mfreview/2016020; Domínguez-Robles, J. et al. Antioxidant PLA Composites Containing Lignin for 3D Printing Applications: A Potential Material for Healthcare Applications Pharmaceutics 11 (4) (2019a). doi: 10.3390/pharmaceutics11040165; Liu, L. et al. Polylactic acid-based wood-plastic 3D printing composite and its properties BioResources 14 (4), 8484-8498 (2019b)), poly hydroxyl butyric acid PHA (Vaidya, A. A. et al. Integrating softwood biorefinery lignin into polyhydroxybutyrate composites and application in 3D printing Materials Today Communications 19, 286-296 (2019) doi: 10.1016/j.mtcomm.2019.02.008) and keratin (Grigsby, W. J. et al. Combination and processing keratin with lignin as biocomposite materials for additive manufacturing technology Acta Biomater. 104, 95-103 (2020) doi: 10.1016/j.actbio.2019.12.026) have all been found amenable to FDM. Likewise, blends of lignin with fossil-based thermoplastics such as nylon (Nguyen, N. A. et al. A path for lignin valorization via additive manufacturing of high-performance sustainable composites with enhanced 3D printability Sci. Adv. 4, 138-152 (2018b)) and ABS (Nguyen, N. A. et al. A general method to improve 3D-printability and inter-layer adhesion in lignin-based composites Appl. Mater. Today 12, 138-152 (2018a). doi: 10.1016/j.apmt.2018.03.009) can be processed with FDM.

A few research articles have demonstrated the successful implementation of wood polymers as inks in DIW. Most commonly, gel-forming cellulosic materials such as carboxymethylcellulose, cellulose nanocrystals (CNCs), cellulose nanofibrils (CNFs), cellulose acetate, methylcellulose and acetoxypropyl cellulose have been successfully printed with DIW.

The implementation of lignin in DIW is scarce, which is due to the limited solubility of technical lignins in water and in common organic solvents.

Jiang et al., (Jiang, B. et al. Lignin-Based Direct Ink Printed Structural Scaffolds. Small 2020, 16, 1907212) relates to the direct ink writing of gels comprising lignin and a wetting agent known as Pluronic 127, a triblock copolymer.

Zhang et al., (Zhang, X. et al. Three-Dimensional Printed Cell Culture Model Based on Spherical Colloidal Lignin Particles and Cellulose Nanofibril-Alginate Hydrogel, Biomacromolecules 2020, 21, 1875-1885) describes the printing of colloidal lignin particles with cellulose nanofibrils.

Gleuwitz et al., (Gleuwitz, F. R. et al. Lignin in bio-based liquid crystalline network material with potential for direct ink writing. ACS Appl. Bio Mater. 2020, 0c00661) describes printed blends of organosolv lignin and lyotropic hydroxypropyl cellulose.

Ebers et al., (L.S. Ebers, et al. Direct Ink Writing of Fully Bio-Based Liquid Crystalline Lignin/Hydroxypropyl Cellulose Aqueous Inks: Optimization of Formulations and Printing Parameters, ACS Appl. Bio Mater. 2020, 3, 6897-6907) describes the use of lyotropic blends of organosolv lignin and hydroxypropyl cellulose in direct ink writing.

Hydroxypropylation of lignin has been described in the literature (R.K.Jain, Wolfgang G. Glasser, Lignin Derivatives: Functional ethers, Holzforschung 47 (1993), 325-332) and has been found to significantly alter the properties of unmodified lignin.

The lignin-based compositions described in the prior art are not fully satisfactory in terms of e.g., ease of manufacturing, in particular solidification, and property profile for additive manufacturing. There thus exists an ongoing need for compositions based on wood materials, respectively wood components, which are suitable for use in additive manufacturing, in particular direct ink writing.

There is additionally a need to provide molecularly engineered, fully bio-based lignins capable of free-shaping by direct ink writing and capable of consolidation into a range of material performances, spanning the mechanical spectra from the strong or stiff to the highly plastic.

It was thus an object of the present invention to provide improved compositions suitable for additive manufacturing, in particular direct ink writing, the compositions particularly having molecularly engineered material properties.

### DESCRIPTION OF THE INVENTION

This object has been achieved with the compositions in accordance with claim 1, the use in accordance with claim 11 and the method in accordance with claim 12.

Preferred embodiments of the compositions in accordance with the present invention are defined in the dependent claims and described in more detail in the description hereinafter.

The composition in accordance with the present invention comprises
a) a functional ether of lignin.
b) a functional ether of cellulose and
c) a solvent comprising an aliphatic alcohol and optionally water.

Component a) in the composition in accordance with the present invention is a functional ether of lignin. The content of the functional ether of lignin in the composition is preferably at least 25 wt. % based on the combined weights of functional ether of lignin and functional ether of cellulose.

The term lignin, as used herein, denotes a class of organic polymers that form essential structural materials in the support tissues of most plants. Lignin is a highly heterogeneous polymer derived from a handful of precursor lignols that crosslink in diverse ways. The lignols that crosslink are of three main types, all derived from primary p-OH cinnamyl alcohol derivatives: coniferyl alcohol (4-hydroxy-3-methoxycinnamyl alcohol or 4-[3-hydroxyprop-1-enyl]-2-methoxyphenol (1), its radical is sometimes called guaiacyl), sinapyl alcohol (4-Hydroxy-3,5-dimethoxycinnamyl alcohol or 4-[3-Hydroxyprop-1-en-1-yl]-2,6-dimethoxyphenol (2), its radical is sometimes called syringyl), and p-coumaryl alcohol (4-hydroxycinnamyl alcohol or 4-[3-Hydroxyprop-1-enyl] phenol (3), its radical is sometimes called 4-hydroxyphenyl). The chemical structures of these alcohols are reproduced below:

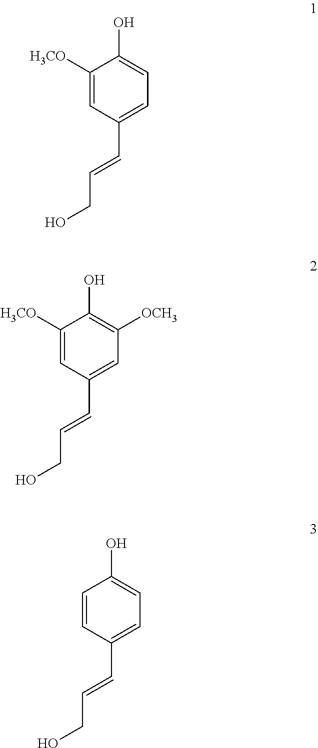 [SMILES: COc1cc(/C=C/CO)ccc1O ; COc1cc(/C=C/CO)cc(OC)c1O ; OC/C=C/c1ccc(O)cc1]

As can be seen from formulae (1) to (3) above, polymeric lignin comprises phenolic and aliphatic hydroxyl groups, which can be modified to ether groups.

The term functional ether of lignin as used herein is intended to cover lignin wherein at least a part of the phenolic hydroxyl groups has been converted to ether groups. Preferably, an amount of 60 to 99.9, more preferably 75 to 99.9 and particularly preferably 85 to 99.9% of the phenolic hydroxyl groups originally present in the lignin are converted to ether groups in the lignin ethers which are used as component a) in the composition in accordance with the present invention. It is also possible to quantitatively convert the phenolic hydroxyl groups to functional ether groups.

The aliphatic hydroxyl groups may also be converted to a certain degree into ether groups but in general the degree of conversion is significantly lower than the degree of conversion of the phenolic hydroxyl groups. For the purpose of the present invention, the degree of conversion of the phenolic hydroxyl groups is used.

The conversion of the phenolic hydroxyl groups into ether groups can be effected in accordance with procedures known to the skilled person and which have been described in the literature so that no further details need to be given here. Furthermore, conversion of the phenolic hydroxyl groups into ether groups is described in the example of the invention below.

Preferred functional ethers of lignin in the composition in accordance with the present invention are hydroxyalkyl ethers. Such ethers may be preferably obtained by the reaction of lignin with alkylene oxides under alkaline conditions. Preferred alkylene oxides useful in this regard are alkylene oxides with 2 to 6 carbon atoms, particularly preferred are ethylene oxide (yielding hydroxyethylated lignin) and propylene oxide (yielding hydroxypropylated lignin) as same are readily commercially available. In the recent past, the oxyalkylation of lignin with alkylene carbonates instead of the respective alkylene oxides has been described in the prior art, using a suitable catalyst. This avoids the use of alkylene oxides which have explosion hazards. The skilled person will select the best suited oxyalkylation method based on his professional experience and taking into account the specific circumstances of the individual application case.

The degree of conversion of the phenolic hydroxyl groups to the ether groups can e.g. be determined by quantitative 31P-NMR. The signals of the phenolic hydroxyl groups disappear depending on the degree of conversion and a new peak occurs which can be assigned to the new aliphatic groups which are formed as a result of the oxyalkylation. This peak can also be differentiated from the aliphatic hydroxyl groups present in the lignin before the oxyalkylation. Using this technique it is thus possible to quantitatively determine the amount of phenolic hydroxyl groups converted into ether groups during the oxyalkylation.

The lignin which is used to obtain the functional ether thereof is not subject to limitations. Any lignin derived from any type of wood can be principally used.

A preferred type of lignin is so called organosolv lignin (hereinafter referred to as OSL), i.e. lignin obtained in accordance with the so called organosolv pulping technique. It is also possible, however, to use lignin obtained by kraft or sulphite pulping. Soda lignin may also be used in the context of the present invention. Lignins obtained from these pulping techniques are commercially available from various sources.

Organosolv is a pulping technique that uses an organic solvent to solubilise lignin and hemicellulose. It has been considered in the context of both pulp and paper manufacture and biorefining for subsequent conversion of cellulose to fuel ethanol. Organosolv has several advantages when compared to other popular methods such as kraft or sulfite pulping. In particular, the ability to obtain relatively high-quality lignin adds value to a process stream otherwise often considered as waste. Organosolv solvents are easily recovered by distillation, leading to less water pollution and elimination of the odour usually associated with kraft pulping.

Organosolv pulping involves contacting a lignocellulosic feedstock such as chipped wood with an aqueous organic solvent at temperatures ranging from 140 to 220° C. This causes lignin to break down by hydrolytic cleavage of alpha aryl-ether links into fragments that are soluble in the solvent system. Solvents used include acetone, methanol, ethanol, butanol, ethylene glycol, formic acid, and acetic acid. The concentration of solvent in water ranges from 40 to 80%. Higher boiling solvents have the advantage of a lower process pressure which has to be weighed against the more difficult solvent recovery by distillation. Ethanol is often used as the preferred solvent in the organosolv process due to low cost and easy recovery. Although butanol has been shown to remove more lignin than other solvents and solvent recovery is simplified due to immiscibility in water, its high cost limits its use.

The molecular weight distribution of organosolv lignin, determined via the polydispersity index (PDI) is typically rather narrow and usually PDI increases upon the etherification (hydroxyalkylation).

Compared to Kraft lignin and soda lignin, organosolv lignin has usually a lower molecular weight. The weight average molecular weight (Mw) is typically in the range of from 1500 to 8000 g/mol and the PDI (the ratio of weight average molecular weight to number average molecular weight) is typically between 1.3 and 2.3. Upon hydroxyalkylation, the weight average molecular weight increases and is usually in the range of from 4000 g/mol to 16 000 g/mol, preferably in the range of from 5000 g/mol to 10 000 g/mol. The increase of molecular weight indicates that coupling reactions within the lignin structure occur.

The functional ether of lignin in accordance with a preferred embodiment of the present invention is a bleached lignin ether. This offers the opportunity to change the dark color to a lighter color. Also, it offers the possibility of altering the mechanical properties (tensile properties). Performing the etherification (e.g. hydroxyalkylation) prior to bleaching is advantageous, as the functional ether is more reactive than native lignin and also free phenolic hydroxyl groups were found to cause dark coloring of lignin, thus blocking those groups enhances the chance for a lighter color in oxidized lignin.

Bleaching can, for example, be effected through reaction of the lignin ether with an oxidizing agent such as a metal oxide or hydrogen peroxide. pH has an influence on the lignin oxidation and usually the reaction is carried out under alkaline conditions. The enhanced lignin solubility under alkaline conditions accelerates the hydroxyl group deprotonation.

For oxidizing the lignin ether, hydrogen peroxide has to be activated, which is typically done by adding an acid leading to the formation of peroxy acid. The formed peroxy acid drives the oxidation of lignin as it reacts like an electrophile. Lignin is as a result degraded (accompanied by a decrease in molecular weight compared to the starting material). The decrease in molecular weight compared to the lignin ether before bleaching is usually in the range of from 20 to 70% (weight average molecular weight). The concentration of hydrogen peroxide solution used has an influence on the degree of oxidation. The concentration of hydrogen peroxide usually is in the range of from 8 to 60 wt %, preferably in the range of from 10 to 55 wt %. Increasing the hydrogen peroxide content during bleaching leads to a higher amount of carboxyl groups and less carbonyl groups.

³¹P-NMR shows that the amount of total OH decreases and carboxyl groups increase with bleaching. ¹³C-NMR indicates the disappearance of aromatic carbons with bleaching and formation of new methyl groups. With gel permeation chromatography (GPC) it can be shown that bleaching decreases the molecular weight compared to unbleached lignin.

The composition in accordance with the present invention comprises as component b) a functional ether of cellulose.

Cellulose ethers are water-soluble polymers produced by the chemical modification of cellulose. They are formed by partial or complete substitution of the hydrogen atoms of the hydroxyl groups in cellulose. This reaction is called etherification. Cellulose ether is the powdered cellulose ether generated with wood fiber or refined short cotton fiber as the main raw materials, after chemical treatment and by the reaction of etherifying agents. The production process of cellulose ether starts with the extraction of cellulose from cotton or wood, which then transforms into alkaline cellulose after adding sodium hydroxide and by chemical reaction (alkaline solution). Under the action of etherifying agents (etherification reaction), cellulose ethers are generated from alkaline cellulose through such processes as washing with water, drying and grinding.

The molecular structure of cellulose is composed of the molecular bonds of dehydrated glucose units. Each glucose unit contains three hydroxyl groups. Under certain conditions, the hydroxyl groups can be substituted by methyl, hydroxyethyl, hydroxypropyl and the like groups, and can form cellulose of different varieties (for example, if substituted by methyl, then it is called methyl cellulose; if substituted by hydroxyethyl, then it is called hydroxyethyl cellulose; if substituted by hydroxypropyl, then it is called hydroxypropyl cellulose).

Preferred functional cellulose ethers in accordance with the present invention are hydroxyalkyl ethers. Examples are hydroxypropyl methylcellulose (HPMC), hydroxyethylcellulose (HEC) and derivatives such as ethyl hydroxyl cellulose ethers (EHEC) or ethyl methyl hydroxyethyl ethers (MEHEC), hydroxypropyl cellulose (HPC) and derivatives, to name just a few representatives, of which HPC and derivatives are particularly preferred in accordance with the present invention. A large variety of functional ethers of cellulose is commercially available from a variety of sources.

The functional ether of cellulose is not subject to any particular limitation with regard to e.g. molecular weight or degree of substitution of the glucose hydroxyl groups and any such product containing functional ether groups can be principally used. In some cases hydroxyalkylated cellulose ethers, in particular hydroxyethyl cellulose or hydroxypropyl cellulose and the derivatives of these ethers have been found to be particularly suitable for use in the composition of the present invention.

The weight ratio of functional ether of lignin to functional ether of cellulose in the composition in accordance with the present invention is preferably in the range of from 25:75 to 60:40, more preferably in the range of from 30:70 to 50:50. It may also be preferred that the weight ratio of functional ether of lignin to functional ether of cellulose in the composition is in the range of from 25:75 to 75:25, from 25:75 to 65:35, from 25:75 to 55:45, from 25:75 to 50:50, from 30:70 to 60:40, or from 30:70 to 55:45.

The composition in accordance with the present invention comprises a solvent comprising an aliphatic alcohol and optionally water, wherein the aliphatic alcohol is preferably a C₁ to C₆ alkanol. A preferred alkanol is ethanol due to its ready availability and high vapour pressure. Preferably, the solvent comprises or consists of a mixture of an aliphatic alcohol and water.

The weight ratio of water to alcohol is preferably in the range of from 10:90 to 90:10, more preferably in the range of from 20:80 to 80:20 and most preferably in the range of from 35:65 to 65:35.

The solids content of the composition in accordance with the present invention is preferably in the range of from 40 to 65 wt %, more preferably in the range of from 45 to 60 wt %, most preferably in the range of from 50 to 55 wt %, based on the total weight of the composition.

The compositions of the present invention can be obtained according to processes known per se. According to an exemplary process of the invention, functional ether of lignin and functional ether of cellulose are added to a solvent or solvent mixture of the invention with the desired weight ratio of water: alcohol in a layer wise manner. Thereafter the vial is sealed and let to rest for a period of time preferably between 24 and 72 hours at room temperature. Thereafter the components can be mixed mechanically and again left to stand for another 6 to 36 hours. Thereafter, the blend is transferred to a cartridge and centrifuged for 30 min at appr. 4500×g.

The foregoing process is just an example; the skilled person will use its professional knowledge to design a suitable manufacturing process.

In one aspect, the invention relates to a method of production of a composition suitable for direct ink writing comprising the steps of: a) etherification of lignin to produce a functional ether of lignin, b) etherification of cellulose to produce a functional ether of cellulose, c) solution of the functional ether of lignin and the functional ether of cellulose in a solvent comprising an aliphatic alcohol. The method is preferably such that the content of the functional ether of lignin in the composition is at least 25 wt. % based on the combined weights of functional ether of lignin and functional ether of cellulose.

In embodiments, the method of the invention directly utilizes functional ether of lignin and functional ether of cellulose.

In embodiments of the method, the etherification of lignin comprises the hydroxyalkylation of lignin, preferably by reaction of an alkylene oxide with lignin under alkaline conditions wherein the alkylene oxide is preferably ethylene oxide or propylene oxide.

In embodiments of the method of the invention, the etherification of cellulose comprises the hydroxyalkylation of cellulose, preferably by reaction of an alkaline cellulose with an etherifying agent, preferably to produce hydroxyethyl cellulose or hydroxypropyl cellulose.

In embodiments of the method of the invention, the method further comprises bleaching the functional ether of lignin after the etherification, wherein the bleaching is preferably carried out by reaction of the functional ether of lignin with an oxidizing agent, preferably a metal oxide or more preferably hydrogen peroxide under alkaline conditions.

In one aspect of the invention, the composition of the present invention can be used as ink in direct ink writing (DIW), a 3D printing process.

As mentioned earlier, the main challenge in DIW is to achieve suitable viscoelastic properties so that the ink can easily flow through the nozzle during printing and form free standing structures after extrusion.

Lignin, due to its limited solubility in most common solvents, has been rarely used until today as a major component of inks for direct ink writing. The respective inks contained less than 25 wt % lignin, based on the solids component of the ink. In contrast, the compositions of the present invention may contain higher amounts of the functional ether of lignin thus enabling to use more lignin, which is an economically very interesting raw material. This is a great advantage of the present invention, since lignin is a “waste” material that is generated during paper manufacturing.

In preferred embodiments of the invention, the composition comprises at least 25 wt. %, at least 30 wt. %, at least 35 wt. %, at least 40 wt. % or at least 45 wt. % of the functional ether of lignin based on the combined weights of functional ether of lignin and functional ether of cellulose. It was surprisingly found that at proportions of at least 25 wt. % the ink was not only more ecological but was more printable, holding a sufficiently stable form on application to a substrate during the stages of an additive printing process. In this manner, discrete layers could be printed over one another without ink applied to a higher layer merging into the lower layers. The compositions having at least 25 wt. % functional ether of lignin based on the combined weights of functional ether of lignin and functional ether of cellulose therefore displayed excellent stacking behaviour, as demonstrated by the Examples below.

As shown in the examples, by using compositions according to the present invention it is possible to print complex models/objects. This is due to the unexpected properties of the composition that are partially achieved by modifying lignin by etherification which leads to an increased solubility. This increased solubility makes it possible to use an aliphatic alcohol, preferably even mixed with water, as a solvent of the composition. Aliphatic alcohols, such as preferably ethanol, evaporate quickly, which allows printing of complex shapes due to rapid solidification.

An important advantage of the compositions of the invention is that in embodiments these are made entirely from biological, wood-based polymers, which are biodegradable.

The fact that in embodiments of the inventive composition it is possible to use bleached lignin, such as bleached functional ether of lignin, is advantageous, since this results in a color change of the usually dark or black lignin, so that the color of printed objects can be adjusted.

Furthermore, unmodified lignin, when used in combination with cellulose in inks for direct ink writing, has to be solubilized separately as it would not dissolve in the desired amounts in mere water/alcohol mixtures. Thus, usually in such compositions, lignin is solubilized with a mixture of water, alcohol and an acid, which requires a work-up to remove the acid which is usually undesirable in direct ink writing.

Thus, the present invention provides compositions with a high lignin content (in the form of a functional lignin ether) which can be easily prepared, and which are suitable for direct ink writing resulting in products having a good shape fidelity and showing fiber formation and layer stacking during the printing process, which is desirable and leads to stable final products.

### FIGURES

The following figures exemplify certain aspects and embodiments of the present invention. However, the scope of the present invention is not limited to these examples but is defined in the attached claims.

FIG. 1: ¹H-NMR spectra of acetylated OSL, HPL and B—H-OSL.

FIG. 2: Quantitative ³¹P-NMR spectra of OSL, HPL and bleached lignin with corresponding signal assignments.

FIG. 3: Results of delta E for bleached lignin in comparison to HPL and OSL.

FIG. 4: Images of OSL (a), HPL (b), mildly (c) and harshly (d) bleached lignin.

FIG. 5: Stress-strain curves of samples printed with 50% HPC and 50% OSL (a), HPL (b), B—H—OSL_mild (c), B—H—OSL_harsh (d).

FIG. 6: Effect of shear rate on viscosity for organosolv lignin (OSL).

FIG. 7: Viscosity recovery behaviour of OSL.

FIG. 8: Effect of shear rate on viscosity for hydroxypropyl lignin (HPL)

FIG. 9: Viscosity recovery behaviour of HPL.

FIG. 10: Effect of shear rate on viscosity for mildly bleached HPL.

FIG. 11: Viscosity recovery behaviour of mildly bleached HPL.

FIG. 12: Effect of shear rate on harshly bleached HPL.

FIG. 13: Viscosity recovery behaviour of harshly bleached HPL.

FIG. 14A: Fiber formation and layer stacking behaviour of samples with a 50% solid content and lignin/HPC ratios of 10/90, 30/70 and 50/50. a: OSL, b: HPL, c: mildly bleached lignin, d: harshly bleached lignin.

FIG. 14B: Fiber formation and layer stacking behaviour of samples of an OSL precursor solution with a 50% solid content and OSL/HPC ratios of 10/90, 20/80, 30/70, 40/60, 50/50, 60/40 and 70/30.

FIG. 14C: Fiber formation and layer stacking behaviour of samples of an OSL precursor solution with a 60% solid content and OSL/HPC ratios of 30/70, 35/65, 40/60, 45/55, 50/50, 55/45, 60/40.

FIG. 15: 3D printed lattice structures and human ear models using different lignins. Printability in complex shapes is enabled for all blends with molecularly tuned lignin (HPL, mb-HPL and hb-HPL).

FIG. 16: Summary of the effect of hydroxypropylation and bleaching on the modulus and elongation of the printed films. All samples had a solid content of 52.5% and contained respectively 30, 40 and 50% OSL (a), HPL (b), mb-HPL (c) and hb-HPL (d).

### EXAMPLES

The following examples exemplify the present invention. However, the scope of the present invention is not limited to these examples but is defined in the attached claims.

### Hydroxypropylation of Lignin

The procedure for hydroxypropylation followed a published protocol (Jain, R. K. et al. Lignin Derivatives. II. Functional Ethers. 1993, Holzforschung 47 (4), 325-332; Wu, L.C.-F. et al.

Engineering plastics from lignin. I. Synthesis of hydroxypropyl lignin. J Appl Polym Sci 29, 1111-11231984).

10 g of organosolv lignin (OSL) were weighed in a round-bottom flask and diluted in 40 ml 1M NaOH under ice cooling. An access amount of propylene oxide (12 ml) was added drop-by-drop. During the addition of propylene oxide (PO), the pH was adjusted to 10.5 with diluted H₂SO₄. The reaction was left to stir for one night. On the next day, the pH was decreased to a value of 3 using H₂SO₄. The precipitate was allowed to settle for one day and then the liquid was removed. The precipitate, hydroxypropylated lignin (HPL), was collected, washed three times with water and freeze-dried.

### Bleaching of Hydroxypropylated Lignin (HPL)

The bleaching method was adapted from a published work (Barnett, C.A. et al. 1989. Bleaching of hydroxypropyl lignin with hydrogen peroxide. ACS Symp. Ser. 397, 436-451.).

1 g of HPL were weighed in an evaporating dish, dissolved in an acetic acid/water mixture and hydrogen peroxide was added. Acetic acid/water and hydrogen peroxide together made up a content of 100 ml. The pan was left under the hood in order to allow evaporation of solvents. After the solvents were completely evaporated, bleached lignin (B—H-OSL) was collected and dried in a freeze-dryer. To optimize the parameters for bleaching HPL, different factors were varied including the ratio of acetic acid (AA) to water (H₂O) and the amount of hydrogen peroxide (H₂O₂) added. The amount of H₂O₂ was in relation to the total amount of solvent added to HPL (Table 1).

TABLE 1

| Weight ratio acetic acid:water | Amount of hydrogen peroxide |
|---|---|
| 50:50 | 12.5% |
| 75:25 | 25% |
| 100:0 | 50% |

Samples bleached with 12.5% H₂O₂ are referred to as B—H-OSL_mild and 50% H₂O₂ as B—H-OSL_harsh.

A proposed reaction mechanism for hydroxypropylation and subsequent bleaching of lignin is shown below, wherein the first structure is an organosolv lignin (L), the second structure is a hydroxypropylated lignin (HPL) and the third structure is a harshly bleached hydroxypropyl lignin (B—H-OSL_harsh).

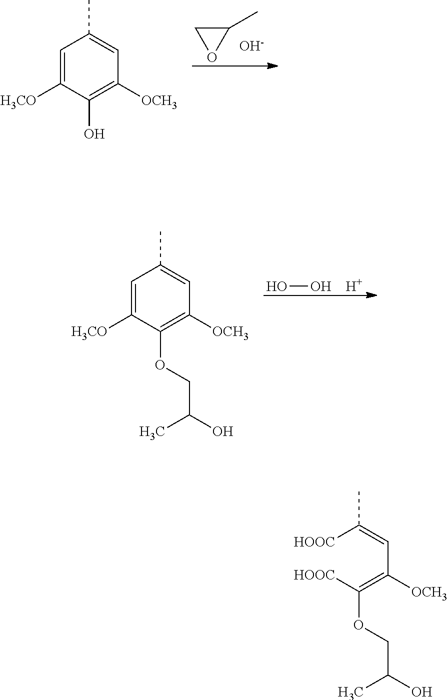

### Structural Characterization

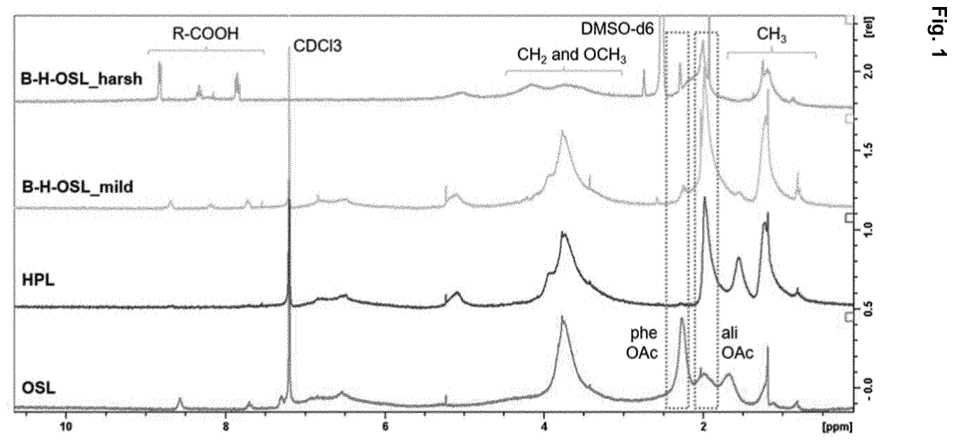

The chemical structure of acetylated OSL, HPL and two bleached lignin (B—H-OSL mild and harsh) was investigated with 1H-NMR in deuterated chloroform (7.3 ppm) (FIG. 1). Harshly bleached lignin was not completely soluble in deuterated chloroform and had to be solubilized in deuterated DMSO instead.

Responses between 1.5 and 0.8 ppm can be assigned to aliphatic moieties and between 2.2 and 1.9 ppm to aliphatic (ali) acetyl groups. Phenolic acetyl (phe) (2.5-2.2 ppm) and methoxy groups (3.1-4.2 ppm) can be detected as well. It can be seen that phenolic as well as aliphatic acetyl groups were present in OSL (FIG. 1).

For HPL, the peak for phenolic acetyl groups (phe COCH₃) disappeared as expected and there is only one peak visible for aliphatic acetoxy groups (ali Oac, 2.0 ppm). In addition, a methyl peak (CH₃) appeared at 1.3 ppm, which is expected for HPL. In comparison to HPL, bleached lignin shows less methyl groups (1.3 ppm).

The harsher the bleaching conditions are (50% H₂O₂), the smaller the methyl peak became in comparison to milder bleaching conditions (12.5% H₂O₂). Another noticeable change could be seen for the methoxy group (3.55-3.95 ppm), which decreases with increasing H₂O₂ content.

For milder bleaching conditions, it can be assumed that the formation of carbonyl groups is favored. Harsher conditions however lead to an increased amount of carboxyl groups.

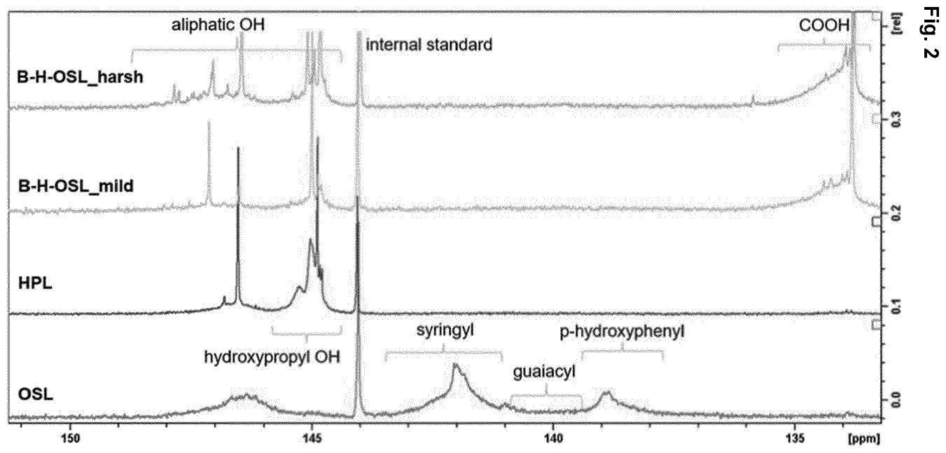

With 31P-NMR of lignin, the presence of different functional groups can be detected, including aliphatic (149.6-145.6 ppm) hydroxyl groups and carboxylic acid (135.9-133.8 ppm). The three different phenolic hydroxyl groups that can be examined are syringyl (144.2-141.2 ppm), guaiacyl (141.0-138.7 ppm) and p-hydroxyphenyl units (138.7-137.2 ppm) (FIG. 2).

To quantify the results of 31P-NMR, the share of the different functional groups was calculated by integration and comparison with the internal standard cholesterol (144.5 ppm) (Table 2).

TABLE 2

| Lignin | OH_{aliphatic} [mmol/g] | | OH_{phenolic} | Total OH | COOH |
|---|---|---|---|---|---|
| sample | native | Hydroxypropyl | [mmol/g] | [mmol/g] | [mmol/g] |
| OSL | 1.5 ± 0.3 | 0.0 | 2.9 ± 0.6 | 4.4 ± 0.4 | 0.07 ± 0.004 |
| HPL | 1.7 ± 0.1 | 3.6 ± 0.8 | 0.3 ± 0.009 | 5.6 ± 1.0 | 0.07 ± 0.006 |
| B-H- | 0.7 ± 0.1 | 2.7 ± 0.4 | 0.0 | 3.4 ± 0.5 | 0.6 ± 0.1 |
| OSL_harsh | | | | | |
| B-H- | 1.5 ± 0.2 | 1.8 ± 0.4 | 0.0 | 3.2 ± 0.3 | 2.5 ± 0.4 |
| OSL_mild | | | | | |

In the above table, OSL is organosolv lignin, HPL is hydroxypropyl lignin, B—H—OSL_harsh is harshly bleached hydroxypropyl lignin and B—H-OSL_mild is mildly bleached hydroxypropyl lignin.

Syringyl units were present the most in OSL with an amount of 1.8 (+0.1) mmol/g lignin. Guaiacyl units made up 0.4 (+0.2) and p-hydroxyphenyl 0.7 (+0.3) mmol/g lignin. The total amount of phenolic OH groups summed up to 2.9 mmol/g and aliphatic groups to 1.5 mmol/g. The amount of carboxylic acid was rather low with a share of 0.07 mmol/g. Overall, hydroxyl groups in OSL had a quantity of 4.4 mmol/g.

For HPL, the phenolic hydroxyl groups disappeared completely (FIG. 2), which is an indication of successful hydroxypropylation of OSL. Moreover, aliphatic hydroxyl groups are present in OSL and HPL. In HPL however, a new aliphatic peak appeared (145.5-146.5 ppm), which can be assigned to the new aliphatic groups that formed as a result of the reaction with propylene oxide. Based on the aliphatic groups and the newly formed hydroxypropyl hydroxyl groups, the degree of substitution (DS) can be calculated for this reaction, which was found to be 0.7 (+0.03) as a mean value of three repetitions of the reaction. Carboxylic acids (135.9-133.8 ppm) were only present in a very small amount in HPL.

In bleached lignin, the total amount of OH groups decreased. Bleaching under harsh conditions favors this trend even more and especially the hydroxypropyl functional groups decline. After bleaching, there were also no phenolic hydroxyl groups present. The amount of carboxylic acids increased considerably with higher amounts of hydrogen peroxide (Table 2).

The molecular weight distribution of the lignin products was determined by gel permeation chromatography. The results are shown in Table 3.

TABLE 3

| Lignin sample | M_{w} (g/mol) | M_{w} (g/mol) | PDI |
|---|---|---|---|
| OSL | 3350 | 1850 | 1.8 |
| HPL | 6810 | 2930 | 2.3 |
| B-H-OSL_harsh | 5070 | 3180 | 1.8 |
| B-H-OSL_mild | 2120 | 1740 | 1.2 |

PDI denotes the polydispersity index which is the ratio of weight average molecular weight to number average molecular weight.

The samples were also analysed by FTIR. The results of FTIR showed that aromatic ring vibrations disappeared with bleached lignin and an increased amount of carbonyl and carboxyl groups was detected. It is thus shown that by hydroxypropylating and bleaching lignin, functional groups are tuned from numerous reactivity-bringing phenolic-OH groups in native lignin to a less reactive lignin derivative (HPL) to an even less reactive aromatic/aliphatic and oxidised carbonyl-rich B-HPL.

Finally, comparison of the samples by eye showed that bleaching resulted in a color change from brown to light yellow.

### Ink Preparation

Hydroxypropyl cellulose (HPC) having a nominal molecular weight of 100,000 (obtained from Alfa Aesar, Karlsruhe) was used as functional ether of cellulose.

For the ink preparation, it was no longer necessary to solubilize modified lignin and HPC separately, as the same solvent system for both biopolymers was used here, hence both could be prepared in one vial. Therefore, a water/ethanol (60%/40% v/v) mixture was prepared. Then, HPC and modified lignin were added to a vial in a layer-wise method with the addition of solvent in between. Vials were sealed with parafilm and let to rest for two days at room temperature. After that, the components were mixed mechanically and again left to stand for one day. Following, the blend was transferred to a cartridge and centrifuged for 30 min. at 4423× g. For Direct Ink Writing, a pressure of 3 bar and speed of 5 mm/s were used. Printed samples were left to dry at air.

The solid content of the ink and the bleached lignin/hydroxypropyl cellulose ratio is given in Table 4:

TABLE 4

| | | Bleached lignin/HPC ratio |
|---|---|---|
| Level | Solid content (%) | (wt %/wt %) |
| Low | 50 | 30/70 |
| Medium | 52.5 | 40/60 |
| High | 55 | 50/50 |

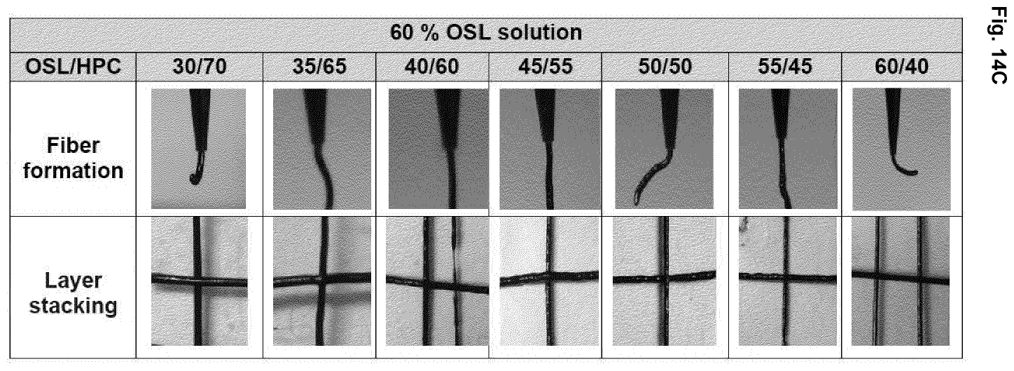

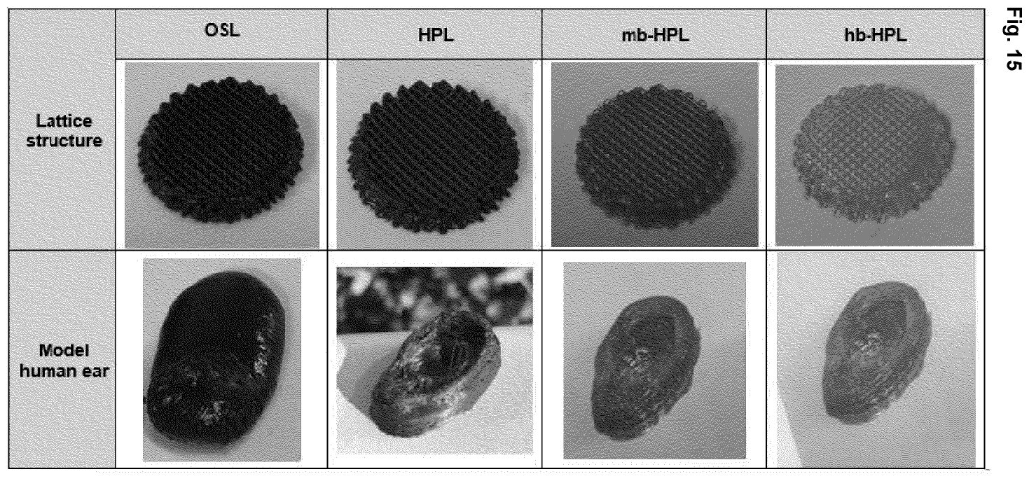

All tested formulations with a solid content of 50% exhibited fiber formation. FIG. 14A shows the fiber formation and layer stacking behaviour of samples with a 50% solid content and lignin/HPC ratios of 10/90, 30/70 and 50/50. The labels a, b, c and d in FIG. 14A represent OSL, HPL, mildly bleached HPL and harshly bleached HPL respectively.

For compositions with a B—H-OSL_harsh/HPC ratio of 10/90, 20/80 and 60/40, layer merging was observed, whereas all other inks display layer stacking. Therefore, inks with ratios of 30/70, 40/60 and 50/50 can be advantageously printed with Direct Ink Writing. Additionally, solid contents of 45 and 55% were tested. Inks having a solid content of 45% form fibers upon extrusion, but the layers of the examined ratios tend to merge, which is not preferred in direct ink writing. In comparison, all formulations with 55% solid content displayed fiber formation and at the same time layer stacking. In comparison to bleached lignin, HPL was not extrudable at solid contents higher than 50%.

FIG. 14B shows further experiments carried out using an OSL/HPC solution having a 50% solid content. The ratios of OSL/HPC were varied across solution samples. The experiments were carried out in accordance with the published method of Paxton et al., 2017. A syringe was loaded with the respective solution sample and centrifuged at 4423×g for 45 minutes to remove air bubbles. Two different needle tips were used, namely a metal needle tip with a constant diameter of 0.57 mm and a conically shaped plastic tip with a diameter of 0.41 mm. The bio-inks were manually extruded by applying light pressure and the shape of the extruded material, as fibers or as droplets, was visually monitored. To investigate layer stacking or merging, two layers were extruded on top of one another and visually observed.

The pre-screening tests showed that for most solutions a conical outlet channel for the ink was preferred, in particular to avoid clogging effects seen in the needle tip of constant diameter. The conical shaped plastic tip was found particularly suitable for extrusion of the inks.

As can be seen in the results of FIG. 14B, with OSL/HPC ratios of 10/90, 20/80 and 30/70 the ink exited the outlet in drop-like shapes. For ratios of 40/60 and above, fibers were formed upon extrusion, as is desirable for direct ink writing. Formulations with OSL/HPC ratios higher than 30/70 enabled good layer stacking rather than the less desirable layer merging which is seen for e.g. the 10/90 OSL/HPC ratio formulation. With OSL/HPC ratios higher than 70/30, the formulations were not extrudable. It is therefore calculated that an OSL/HPC ratio of at least 25/75 is needed for layer stacking.

FIG. 14C shows yet further experiments carried out using an OSL/HPC solution having a 60% solid content. The ratios of OSL/HPC were again varied across solution samples. At the 60% solid content, OSL/HPC ratios between 30/70 and 60/40 were found to be printable. All of the samples in this range exhibited fiber formation and layer stacking.

For samples having a solid content lower than 45% in the precursor solution, extrusion was not found to be successful as the viscosity of the ink was too low. The ink was also found to flow from the needle at rest. On the other hand, OSL samples having a solid content higher than 60% were too viscous to be extruded by simple manual pressure.

These pre-screening tests thus revealed that precursor OSL solutions between 50 and 60% solid content in combination with OSL/HPC ratios of 30/70 to 60/40 are theoretically printable. In further tests, a range of inks was prepared with OSL solutions between 45 and 60% and ratios of 30/70 to 60/40 and simple rectangles were printed using direct ink writing. Continuous printing was found to be most successful for OSL precursor solutions between 45 and 50% solid content and OSL/HPC ratios of 30/70, 40/60, 50/50 and 60/40. Other formulations presented drawbacks such as clogging problems.

### Colorimetry

Inks with B—H-OSL_harsh had a yellow color. This yellowness arises probably from oxygen-containing functional groups such as carbonyl and carboxyl groups.

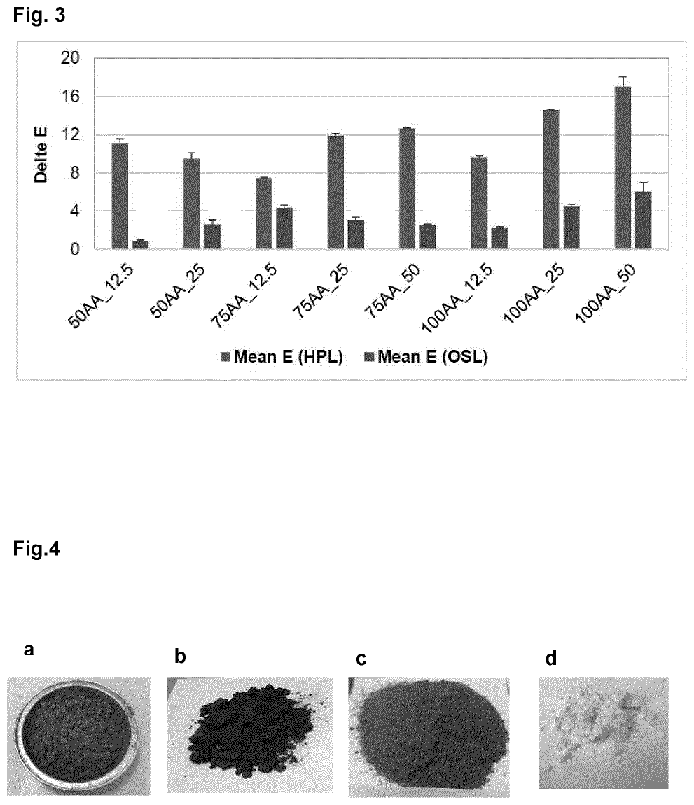

Compared with OSL having a dark appearance, the color was much lighter after bleaching. FIG. 3 and FIG. 4A-D allow the effect of bleaching on the color to be observed. As visible by eye, HPL has a slightly darker color than OSL. However, upon mildly bleaching HPL a lighter color is detectable, which is even more pronounced in harshly bleached lignin having a yellowish color. The color of B—H-OSL samples was measured using a colorimeter and delta E was calculated in comparison to HPL and OSL. In general, the higher the value of delta E is, the higher is the color difference between tested samples. It can be seen that delta E increases with higher H₂O₂ concentrations and increasing AA ratio. The highest color difference between OSL and HPL is achieved for the sample containing a ratio of 100 AA and 50% H₂O₂ (B—H-OSL_harsh). A value of delta E higher than 5 is considered to be a different color between tested samples, thus harshly bleached lignin gave a successful result for bleaching HPL. When comparing the results of bleached lignin to OSL, the color change is not as high, because the hydroxypropylation of OSL darkened the color.

### Shear-Viscosity and Recovery Experiments

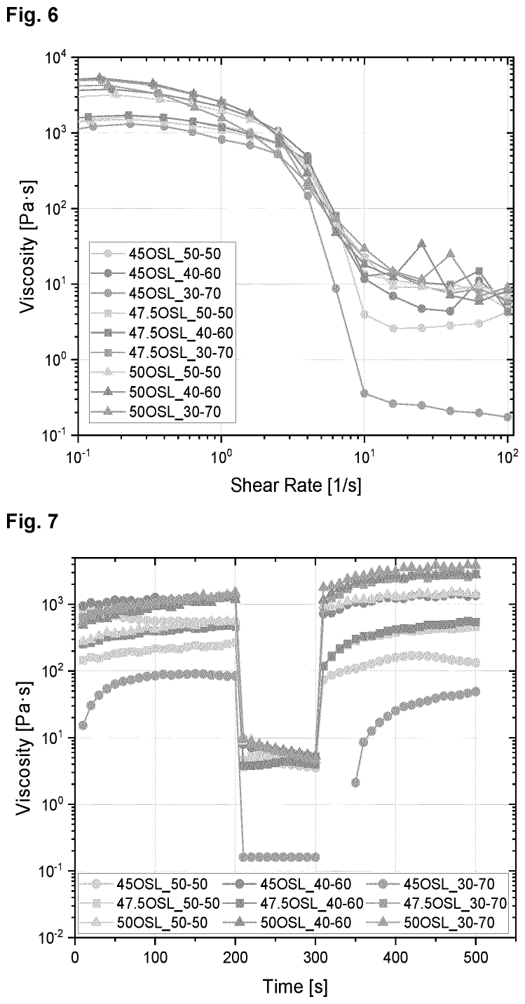

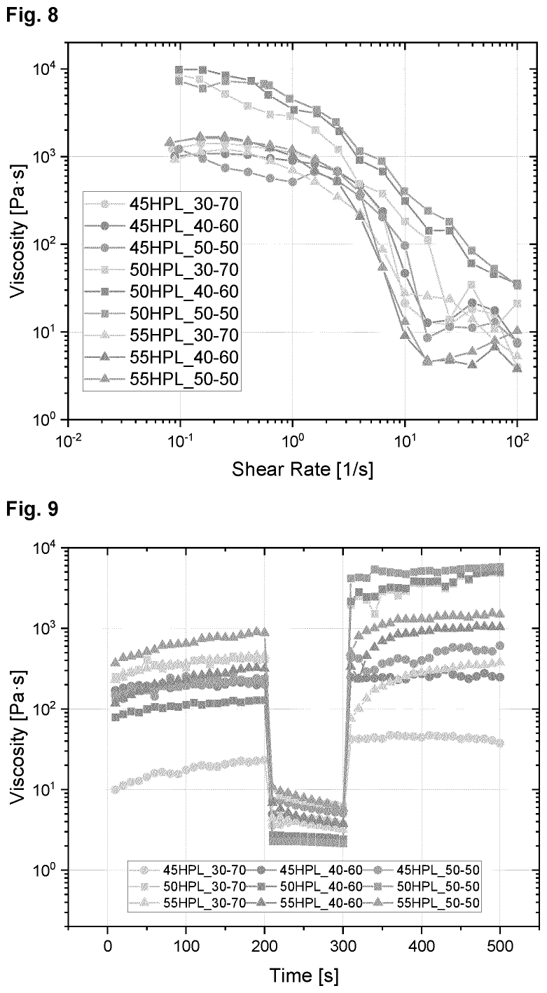

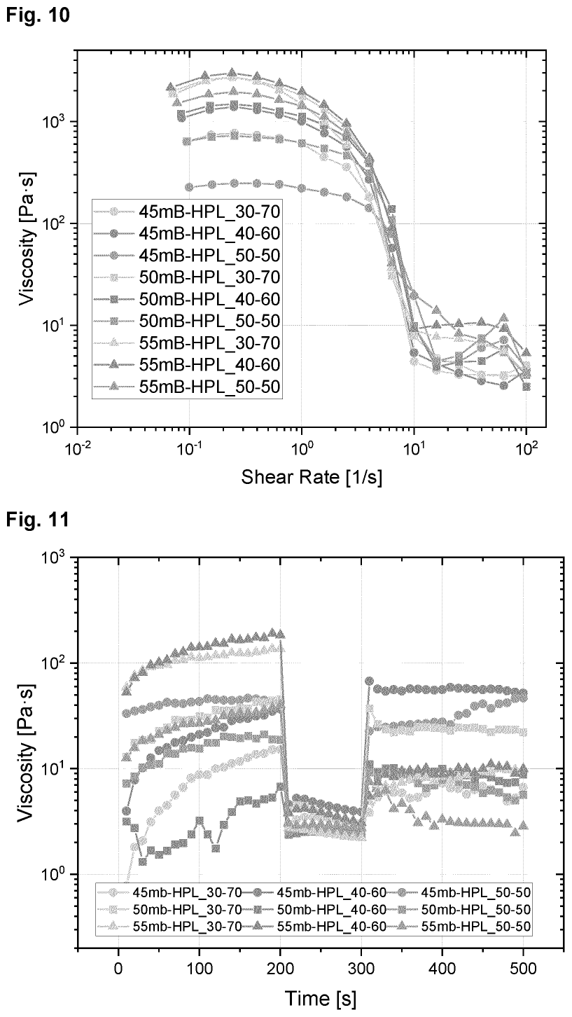

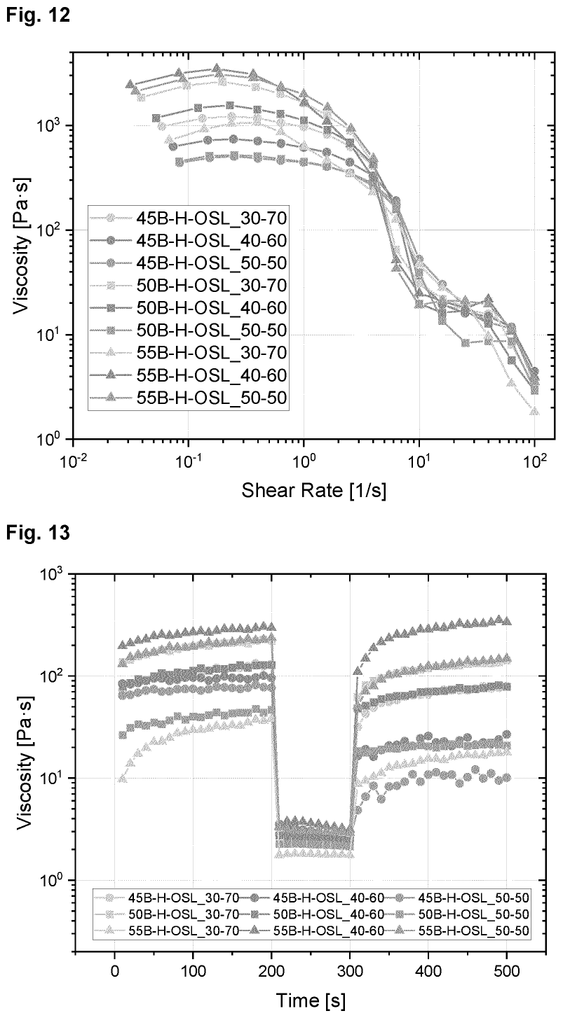

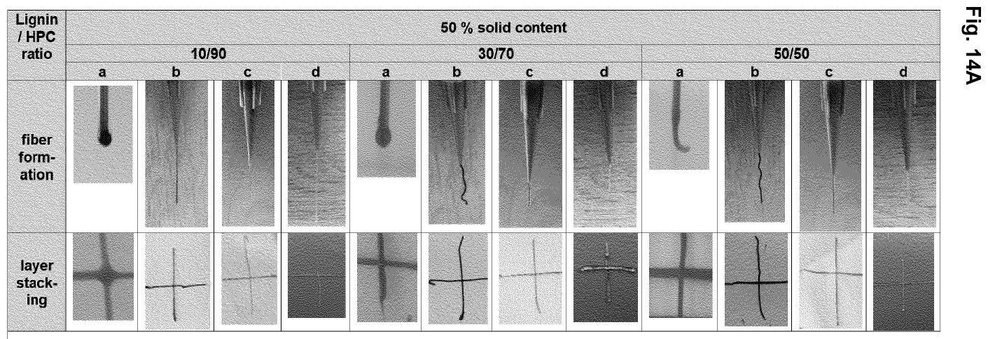

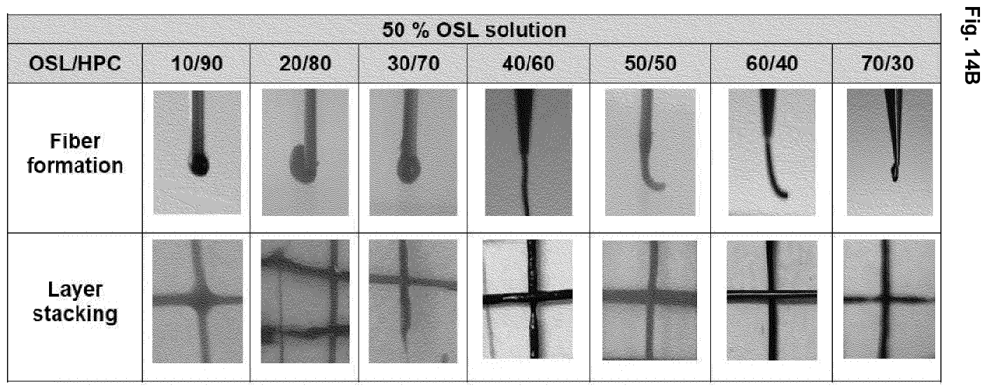

Shear-viscosity experiments were conducted to further study printability of B—H-OSL_harsh bio-inks. Ratii of 30/70, 40/60 and 50/50 were chosen as pre-tests with 50% solid content ascertained layer stacking in this range. The results are summarised in FIGS. 6-13, wherein FIG. 6 shows the effect of shear rate on viscosity for organosolv lignin (OSL), FIG. 7 shows the viscosity recovery behaviour of OSL, FIG. 8 shows the effect of shear rate on viscosity for hydroxypropyl lignin (HPL), FIG. 9 shows the viscosity recovery behaviour of HPL, FIG. 10 shows the effect of shear rate on viscosity for mildly bleached HPL, FIG. 11 shows the viscosity recovery behaviour of mildly bleached HPL, FIG. 12 shows the effect of shear rate on harshly bleached HPL and FIG. 13 shows the viscosity recovery behaviour of harshly bleached HPL.

For all formulations viscosity declined with increasing shear rates, hence the requirement of shear-thinning was fulfilled for 3D printing. A low solid content of 45% led to the lowest values of viscosity. With increasing solid content, viscosity rose and also a higher lignin content promoted high values of viscosity.

The capability of B—H-OSL_harsh/HPC inks to recover, after high shear rates were applied, was assessed using recovery tests. In recovery tests, high shear rate of 895 s-1 between 200 and 300 s are applied, before and after that low shear rate of 0.01 s-1.

Analogously to shear-viscosity results, the recovery behavior of B—H-OSL_harsh/HPC inks was favoured by high solid contents and lignin ratios. The best recovery was achieved for the ink having a solid content of 55% and a B—H-OSL_harsh/HPC ratio of 40/60. Inks with low solid contents showed the weakest recovery behavior. These results suggest that high solid contents along with high lignin ratios are beneficial for the rheological performance of inks containing bleached lignin.

Based on the pre-tests of bio-inks containing HPC and bleached lignin, solid contents of 50, 52.5 and 55% were chosen for Direct Ink Writing along with ratios of 30/70, 40/60 and 50/50 modified lignin/HPC blends. The printed films had a light yellow color and were transparent opposed to the black films obtained with unmodified organosolv lignin. When comparing the films, the ones containing bleached lignin are more flexible than the ones containing unmodified OSL.

Shape Fidelity of Printed Parts with Hydroxypropylated and Bleached Lignin

Printed films were tested for shape fidelity of length, width and thickness in relation to the modeled dimensions. Therefore, the dimensions were measured and the mean value of five replicates was used.

The formulations achieving the highest shape fidelity in length were the ones having a solid content of 50%, whereas a solid content of 55% led to a higher divergence from the model. For the shape fidelity of width, a solid content of 52.5% was favorable, followed by 50% and 55%. All films exhibited a shrinkage in thickness and the divergence in thickness was higher than that for length and width. There was no clear tendency of shape fidelity when taking into account the bleached lignin content. When comparing all three parameters, length, width and thickness, the lowest shape fidelity can be found for films with 50% content of bleached lignin.

### Mechanical Properties

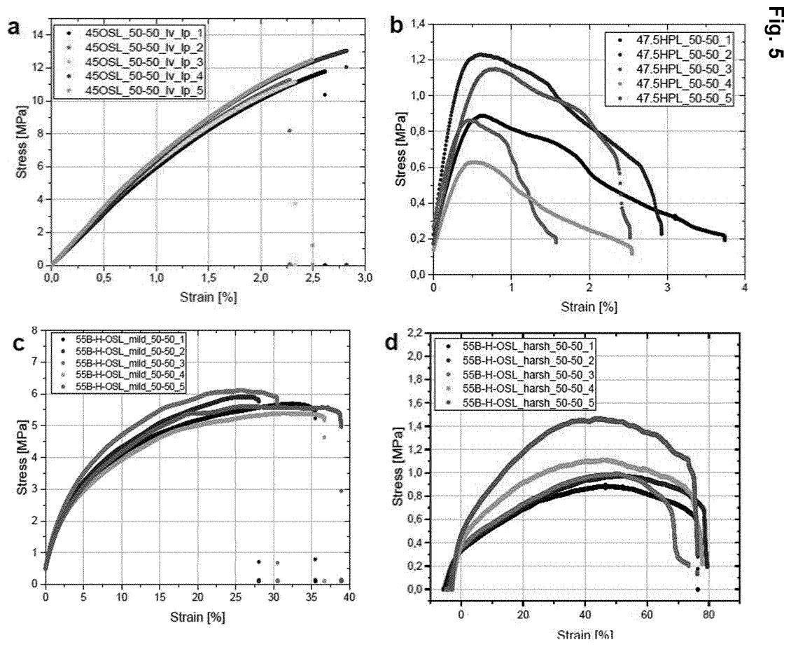

As shown in FIGS. 5A-5D, the stress-strain curves of samples containing HPL were comparable to the ones of OSL in terms of maximum strain that can be reached. The addition of bleached lignin clearly visualized the differences to samples with OSL and HPL. OSL and HPL behave like an elastic or plastic, whereas bleached lignin showed highly plastic and ductile behaviour in blends with HPC. With bleached lignin, the printed films were more stretchable and showed plastic deformation behaviour. Mildly bleached lignin broke at a strain of about 35 to 40%, whereas harshly bleached lignin could be extended up to 80%, thus the higher the degree of bleaching, the higher is the extensibility of the films. The modulus was assessed for samples containing HPL, mildly and harshly bleached lignin and compared to OSL. The following table shows a summary of the results, wherein mb-HPL is mildly bleached hydroxypropylated lignin and hb-HPL is harshly bleached hydroxypropylated lignin.

TABLE 5

| | 30% | 50% | 30% | 50% | 30% | 50% | 30% | 50% |
|---|---|---|---|---|---|---|---|---|
| | OSL | OSL | HPL | HPL | mb-HPL | mb-HPL | hb-HPL | hb-HPL |
| E | 613 ± 36 | 879 ± 72 | 141 ± 12 | 186 ± 23 | 283 ± 46 | 70 ± 21 | 1099 ± 98 | 153 ± 35 |
| [Mpa] | | | | | | | | |
| Rₘ | 7.2 ± 0.6 | 18.1 ± 0.8 | 3.1 ± 0.06 | 1.0 ± 0.1 | 15.0 ± 0.9 | 5.0 ± 0.6 | 7.8 ± 1.2 | 1.9 ± 0.2 |
| [Mpa] | | | | | | | | |
| ε_{b} | 1.1 ± 0.1 | 2.5 ± 0.2 | 1.8 ± 0.6 | 3.1 ± 0.6 | 25.3 ± 4.4 | 42.3 ± 1.5 | 30.1 ± 6.5 | 97.8 ± 11.8 |
| [%] | | | | | | | | |
| Ut | 5.6 ± 0.7 | 30.2 ± 2.4 | 1.5 ± 0.2 | 2.6 ± 0.4 | 209 ± 45.5 | 164 ± 21.2 | 209 ± 10.4 | 136 ± 20.1 |
| [MJ/m³] | | | | | | | | |

Surprisingly, molecular tuning of lignin, in particular-O-bearing functionalities and aromatic/aliphatic ratios-enables varying the modulus from 879 to 153 Mpa and elongation from 2.5 to 97.8% (50% OSL to 50% harshly bleached lignin), shifting the material response from a stiff/strong bioplastic to a ductile/soft bioplastic.

The bleached printed films had a light yellow color and were transparent compared to the black film obtained by unmodified organosolv lignin. With bleached lignin, the printed films were more stretchable and showed more plastic deformation behaviour.

Upon hydroxypropylation of lignin, the modulus decreased in comparison to OSL. For HPL, it could be seen that the modulus became enhanced with higher HPL content, but the values were lower than for OSL. This reduction of modulus could be observed for the whole sample range and can be probably explained with the weak band texture of HPL films. With bleaching of HPL, the modulus reached higher values. When comparing the modulus of bleached lignin with OSL, films containing mildly and harshly bleached lignin have a lower modulus than OSL. The only exception were samples containing 30% harshly bleached lignin, which showed an increase of 50% in modulus. This behavior can be most likely explained by the distinctive band texture of these samples. Mostly harshly bleached lignin samples show superior or comparable results to mildly bleached lignin.

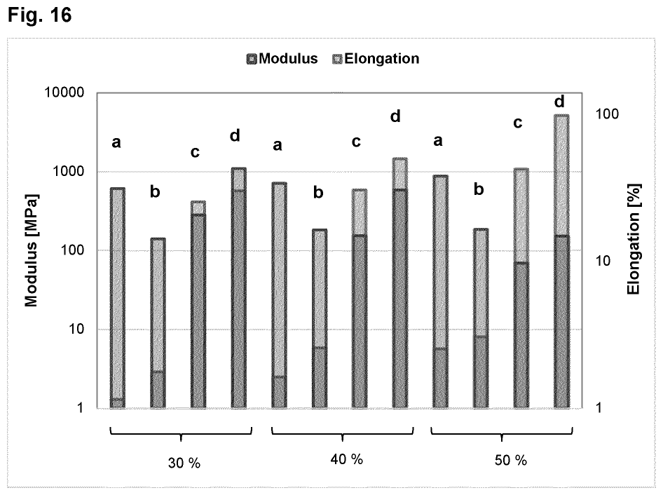

FIG. 16 summarises the effect of hydroxypropylation and bleaching on the modulus and elongation of the printed films, wherein all samples had a solid content of 52.5% and contained respectively 30, 40 and 50% OSL (a), HPL (b), mb-HPL (c) and hb-HPL (d).

Printing of 3D Objects with Bleached Lignin

Using bleached lignin bears the advantage of changing the solvent system. Therefore, the ability of this ink to print 3D objects was assessed. The model of a human ear was chosen, and silicone was used as a reference ink. With the ink containing ethanol and water, it was first possible to print the 3D model, but during solvent evaporation the object collapsed. By removing water from the solvent system and preparing the ink with ethanol alone, the ear was printed successfully and retained its shape after drying.

FIG. 15 exemplifies the printability of 3D lattice structures and human ear models using different lignins. As can be seen in the first column of this figure, simple 3D structures such as a lattice, can be realised with OSL. However, at higher complexities, printing with OSL fails due to the solvents used in the ink. However, with all molecularly tuned lignins it has proven possible to print complex shaped due to the complementary functions of the LC-polysaccharide and the consolidating function of the lignin. The use of ethanol as a solvent further enhances the solidification.

The trial proved that modified and modified bleached lignin/HPC ink can be used to print complex 3D objects using Direct Ink Writing.

### Conclusion of Examples

Hydroxypropylated lignin and mildly as well as harshly bleached HPL preparations were used for preparing inks with HPC and studied with respect to the suitability for Direct Ink Writing. Other than inks from unmodified OSL, HPL and bleached lignin can be dissolved in ethanol. Therefore, HPC and bleached lignin were dissolved in the same solvent system (ethanol/water) and prepared in one vial, saving materials and time in comparison to the preparation of OSL/HPC inks. Pre-tests revealed clearly that inks with a solid content higher than 50% and ratios of 30/70, 40/60 and 50/50 harshly bleached lignin/HPC are printable, as they exhibited fiber formation and layer stacking. Additionally, rheological experiments were conducted. For all samples, shear-thinning was observed. Moreover, it was shown that high solid contents along with high bleached lignin ratios are beneficial for the rheological performance. The rheological behavior of inks with bleached lignin compares well to the one of OSL.

Inks with bleached lignin were printed using Direct Ink Writing. First of all, bleaching lignin leads to a drastic change in color. Unlike HPC/OSL and HPC/HPL films having a dark color, films with HPC/bleached lignin show a light yellow color and are even transparent. The mechanical behavior of films changed from a plastic (OSL and HPL) to a ductile one upon bleaching lignin. Elongation and toughness increased for mildly and harshly bleached lignin, whereas modulus and strength decreased slightly compared to OSL.

As bleaching lignin allowed changing the solvent system, it was possible to print more complex 3D models from inks with HPC. It was proven that removing water from the ink is favourable and printing with pure ethanol allows the 3D model to maintain its shape after solvent evaporation. With purely bio-based compositions, the printing of more complex 3D models has been made possible, thus offering the opportunity to change from petroleum-based to bio-based inks.

1. A composition comprising
a) a functional ether of lignin,
b) a functional ether of cellulose, and
c) a solvent comprising an aliphatic alcohol and optionally water,
wherein the content of the functional ether of lignin in the composition is at least 25 wt % based on the combined weights of the functional ether of lignin and the functional ether of cellulose, wherein the composition is suitable for direct ink writing.

2. A The composition in accordance with claim 1 wherein the functional ether of lignin is a hydroxylalkyl ether.

3. The composition in accordance with claim 1 wherein the functional ether of cellulose is a hydroxyalkyl ether.

4. The composition in accordance with claim 1 wherein the functional ether of lignin is hydroxypropylated lignin.

5. A The composition in accordance with claim 1 wherein the functional ether of cellulose is hydroxypropylated cellulose.

6. A The composition in accordance with claim 1 wherein the aliphatic alcohol is a C₁ to C₆ alkanol.

7. A The composition in accordance with claim 6 wherein the C₁ to C₆ alcohol is ethanol.

8. The composition in accordance with claim 1 wherein the content of the functional ether of lignin is up to 75 wt % based on the combined weights of the functional ether of lignin and the functional ether of cellulose.

9. A The composition in accordance with claim 1 wherein a) and b) constitute from 40 wt % to 65 wt %, based on a total weight of the composition.

10. A The composition in accordance with claim 1 wherein the functional ether of lignin is a bleached lignin ether.

11. A method comprising:
providing the composition in accordance with claim 1 and employing the composition in the direct ink writing.

12. A method of production of a composition comprising:
a) etherification of lignin to produce a functional ether of lignin,
b) etherification of cellulose to produce a functional ether of cellulose, and
c) solving of the functional ether of lignin and the functional ether of cellulose in a solvent comprising an aliphatic alcohol,
wherein a content of the functional ether of lignin in the composition is at least 25 wt % based on combined weights of the functional ether of lignin and the functional ether of cellulose.

13. The method according to claim 12, wherein the etherification of lignin comprises hydroxyalkylation of lignin.

14. The method according to claim 12, wherein the etherification of cellulose comprises the hydroxyalkylation of cellulose, preferably by reaction of an alkaline cellulose with an etherifying agent, preferably to produce hydroxyethyl cellulose or hydroxypropyl cellulose.

15. The method according to claim 12, wherein the method further comprises bleaching the functional ether of lignin after the etherification, wherein the bleaching is preferably carried out by reaction of the functional ether of lignin with an oxidizing agent, preferably a metal oxide or more preferably hydrogen peroxide under alkaline conditions.

16. The composition in accordance with claim 8 wherein the content of the functional ether of lignin is up to 60 wt % based on the combined weights of the functional ether of lignin and the functional ether of cellulose.

17. The composition in accordance with claim 8 wherein the content of the functional ether of lignin is up to 50 wt % based on the combined weights of the functional ether of lignin and the functional ether of cellulose.

18. The method according to claim 13, wherein the hydroxyalkylation of the lignin is accomplished by reacting an alkylene oxide with the lignin under alkaline conditions.

19. The method according to claim 18, wherein the alkylene oxide is ethylene oxide or propylene oxide.
